(19) United States
(12) Patent Application Publication
(10) Pub. No.: US 2014/0042850 A1
(43) Pub. Date: Feb. 13, 2014

(54) ROTOR MAGNETICO DE EFECTO BRÚJULA

(71) Applicants: Augusto Eric Reijer Picozzi, Los Andes (CL); Marco Antonio Fernandez Ordenes, Los Andes (CL)

(72) Inventors: Augusto Eric Reijer Picozzi, Los Andes (CL); Marco Antonio Fernandez Ordenes, Los Andes (CL)

(21) Appl. No.: 13/879,591

(22) PCT Filed: Jul. 1, 2011
(86) PCT No.: PCT/CL11/00038

§ 371 Date: Oct. 28, 2013

(30) Foreign Application Priority Data
Oct. 15, 2010 (CL) 1136-2010

(51) Int. Cl. H02K 47/14

(52) U.S. Cl. CPC H02K 47/14; H02K 53/00
USPC 310/113; 74/DIG. 9

(57) ABSTRACT

The invention “compass-effect magnetic rotor” refers to an iron bar winding to which a DC current is applied to convert it into an electromagnet, this iron bar being centrally mounted on a shaft in such a way that when the whole assembly is oriented North-South the bar will point North-South because it acts as a simple compass, however; when the iron bar is aligned with the Earth's magnetic north, the polarity of the bar is changed, changing the direction of electricity supply and hence the iron bar will rotate permanently and successively thereby attaining continuous rotation of the iron bar on the shaft perpendicular to the center thereof. The energy generated by the Earth's magnetic field is thus utilized and converted into mechanical energy through the permanent rotation of the “compass-effect magnetic rotor,” which in turn converts said energy into electricity by means of a generator connected to the shaft.

### CROSS-REFERENCE TO RELATED APPLICATIONS

International Application: PCT/CL2011/000038

### STATEMENT REGARDING FEDERALLY SPONSORED RESEARCH OR DEVELOPMENT

None

### THE NAMES OF THE PARTIES TO A JOINT RESEARCH AGREEMENT

None.

### BACKGROUND OF THE INVENTION

1. Field of the Invention

The invention “compass-effect magnetic rotor” refers to an iron bar winding to which a DC current is applied to convert it into an electromagnet, this iron bar being centrally mounted on a shaft in such a way that when the whole assembly is oriented North-South the bar will point North-South because it acts as a simple compass, however; when the iron bar is aligned with the Earth's magnetic north, the polarity of the bar is changed, changing the direction of electricity supply and hence the iron bar will rotate permanently and successively thereby attaining continuous rotation of the iron bar on the shaft perpendicular to the center thereof.

The energy generated by the Earth's magnetic field is thus utilized and converted into mechanical energy through the permanent rotation of the “compass-effect magnetic rotor,” which in turn converts said energy into electricity by means of a generator connected to the shaft.

The electrical energy required to magnetize the iron bar is less in magnitude than the electricity produced by the generator of electricity connected to the “compass-effect magnetic rotor” system; and so this results in a new form of power generation by means of the invention of the “compass-effect magnetic rotor.”

2. Description of Related Art

There are many techniques used for equipment to harness the natural energy of wind, hydro and others to covert mechanical energy into a source for electricity, various propellers are designed to make them spin in the wind and generate electricity through this mechanical movement, also the power generated by falling water is used with different types of turbines designed to convert mechanical energy into electrical energy, and many other similar mechanisms exist in the art, where all of them, like the invention compass-effect magnetic rotor, spin a shaft which engages an electric power generator.

### BRIEF DESCRIPTION OF THE DRAWINGS

For further explanation of the invention called “compass effect magnetic rotor” must be described in relation to the figures, wherein:

FIG. 1 shows a three-dimensional view of the “compass-effect magnetic rotor” with the battery system and electric power generation.

FIG. 2 shows a three dimensional view of the “compass-effect magnetic rotor” on its main body and its power connection.

FIG. 3 shows a sectional view of the fixed electrical connection system for generation of electromagnetism.

FIG. 4 shows a sectional view of the moveable electrical connection system for generation of electromagnetism.

### DETAILED DESCRIPTION OF THE INVENTION

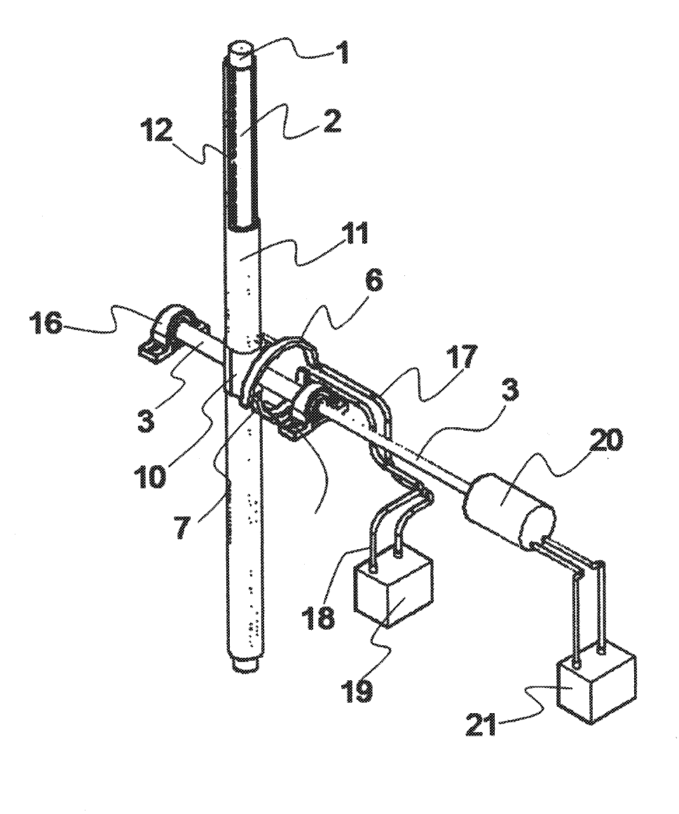

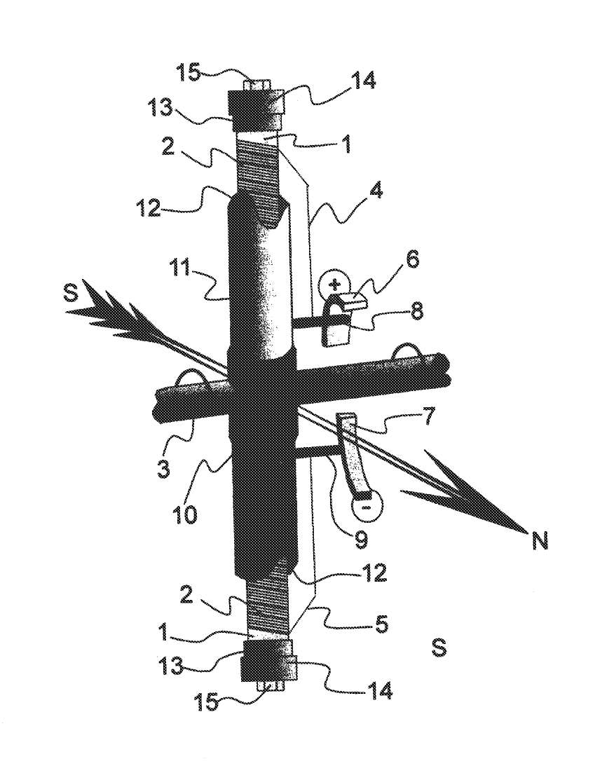

Referring to FIGS. 1 and 2, the “compass-effect magnetic rotor” consists of a circular steel bar 1, preferably with copper wire winding 2 between the ends 13 of the circular steel bar 1 is protected on all surfaces with a protective mantle 12, preferably rubber, a tubular casing covering the whole protective mantle 12 is supported by the ends 13, is secured at each end with a cap 14 attached to the circular steel bar 1 with a steel bolt 15, which in turn can serve to balance the system by installing caps 14 of lesser thickness, the tubular housing 11 at its central part of its length has a mass 10 to connect with the rotation shaft 3 which is mounted on support bearings 16.

The end of the winding wire 4 is channeled and connects positive contact rod 8 in the case of these figures is attached to the tubular housing 11 and the initial end of the winding wire 5 is channeled and connecting negative contact rod 9 also in the case of these figures is attached to the tubular casing 11, but at the other end, both positive contact rod 8 and negative contact rod 9 are equidistant to the center of mass 10.

The positive contact rod 8 is maintained in contact with the positively charged semi-cylindrical plate 6 which is connected by cable 17 to the positive DC terminal of rechargeable battery 19 and the contact bar 9 is maintained in contact with the negatively charged semi-cylindrical plate 7 connected by the cable 18 to the negative DC terminal of rechargeable battery 19 in order to deliver energy, steel round bar 1 is magnetized and its positive charge will align it with the earth's magnetic north and arriving to alignment to with that point, the contact rod 8 comes into contact with the negatively charged plate 7 and the contact bar 9 come into contact with the positively charged plate 6 and circular steel rod 1 changes its polarity and again seeks alignment with the magnetic field of the earth, and in this way circular steel bar 1 spins about the axis of rotation 3 by changing the polarity in each full rotation to remain energized while in contact with positively charged plate 6 and then negatively charged plate 7.

Therefore, spinning circular steel bar 1 will continue to turn rotation shaft 3 which, when connected to an electrical generator 20, produces electrical energy which, because of the length of the circular steel bar 1 exercises a torque about the rotation axis 3 so that the magnitude of the electrical energy produced by the effect of the earth's magnetic field is greater than the magnitude of the electrical energy consumed in magnetized circular steel bar 1, and thus the invention “compass-effect magnetic rotor” has an industrial application.

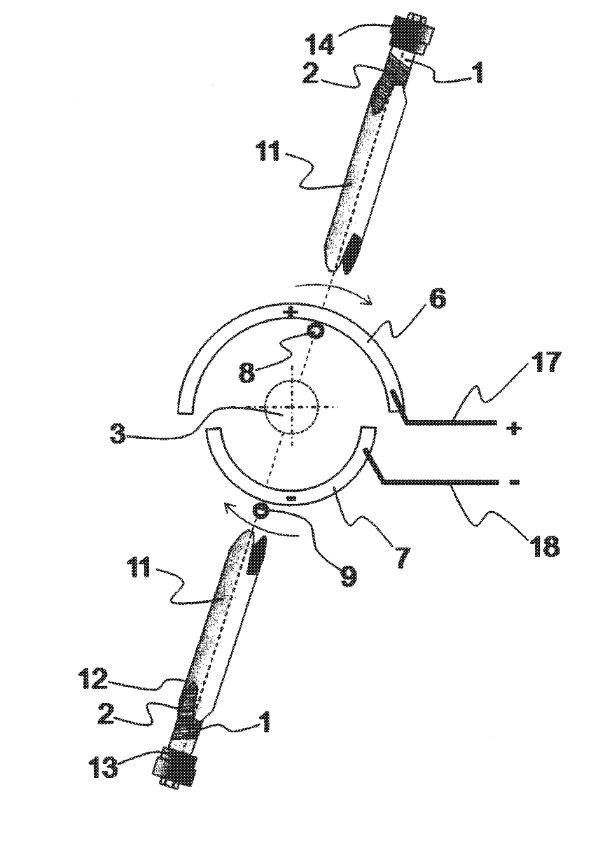

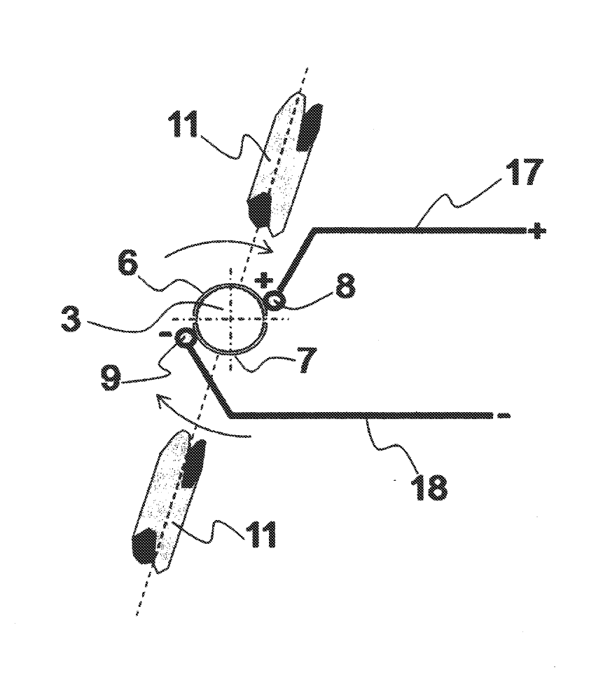

Referring to FIGS. 3 and 4, FIG. 3 indicates the positively charged semi-cylindrical plate 6 and the negatively charged semi-cylindrical plate 7 attached to the structure of the “compass-effect magnetic rotor” and the moving contact bar 8 and contact bar 9 attached to tubular housing 11.

Referring to FIG. 4, indicating the positively charged semi-cylindrical plate 6 and negatively charged semi-cylindrical plate 7 attached to the rotation shaft 3, both movable, and contact rod 8 and contact rod 9, both attached to the structure the “compass-effect magnetic rotor.”

1. The compass-effect magnetic rotor, designed as a steel bar wound with wire to be magnetized, supported at its center, that is positioned on a North-South axis as a compass, this movement will spin a shaft, whose movement is continuous and permanent and attaches this axis with a generator so that it allows to transform the mechanical energy of rotation of the shaft into electrical energy which delivers the generator, as is done in the State of the art with a boiler operated with coal, oil or other fuel to generate steam and move a turbine that rotates a shaft attached to the generator that transforms mechanical energy in electric power, or that attached to the generator shaft can move also by the effect of a propeller powered with wind power or a turbine driven by hydraulic power CHARACTERIZED because the rotor design effect compass to be circular steel bar 1 mounted on the axis of rotation 3 and with power delivered to rechargeable battery 19, winding 2 creating a magnetic field which produces the effect of a compass and orients circular steel bar 1 to Earth's magnetic north; and arriving at this position positive contact rod 8 that contacts the positively charged semi-cylindrical plate 6 moves to contact negatively charged semi-cylindrical plate 7 and negative contact rod 9 that contacts the negatively charged semi-cylindrical plate 7 moves to contact positively charged semi-cylindrical plate 6, thus changing the polarity of the DC current in winding 2 that is supplied by the end of the wire from winding 4 and goes by the initial end wire coil 5, and vice versa by changing the position of the poles of circular steel bar 1 by turning to search again for the North and so on the movement becomes permanently and continuous, moved with the energy generated by the Earth's magnetic field, so move the axis of rotation 3 subject by its support bearings 16 and connected to the electric generator 20 transmitting the mechanical energy that is converted into electrical energy.

2. The compass-effect magnetic rotor, according to claim 1, CHARACTERIZED by a design of the compass-effect magnetic rotor whereby the circular steel bar 1 is mounted in a vertical position, and the axis of rotation 3 in a horizontal position, supported at its opposite ends by bearings bracket 16.

3. The compass-effect magnetic rotor, according to claim 1, CHARACTERIZED by a design of the compass-effect magnetic rotor whereby the circular steel bar 1 is mounted in a horizontal position, and the axis of rotation 3 in a vertical position, supported at its opposite ends by bearings bracket 16.

4. The compass-effect magnetic rotor, according to claim 1, CHARACTERIZED by a design of the compass-effect magnetic rotor whereby one, two or more circular steel bars 1 are mounted in a vertical position, and the axis of rotation 3 is horizontal, with each circular steel bar 1 supported on its opposite ends by bearings bracket 16.

5. The magnetic rotor effect compass, according to claim 1, CHARACTERIZED by a design of the compass-effect magnetic rotor whereby positive contact 8 bar and negative contact bar 9 are both attached to the tubular casing 11, so they rotate and make contact with positively charged semi-cylindrical plate 6 and negatively charged semi-cylindrical plate 7 both of which are attached to the structure of the compass-effect magnetic rotor.

6. The compass-effect magnetic rotor, according to claim 1, CHARACTERIZED by a design of the compass-effect magnetic rotor whereby positively charged semi-cylindrical plate 6 and negatively charged semi-cylindrical plate 7 are both attached to the axis of rotation 3 and contact rod 8 and contact rod 9 are both attached to the structure of the compass-effect magnetic rotor.
